(19) United States
(12) Patent Application Publication
(10) Pub. No.: US 2015/0079553 A1
(43) Pub. Date: Mar. 19, 2015

(54) Language Teaching

(71) Applicant: Jeffrey L. Arnold, Colorado Springs, CO (US)

(72) Inventor: Jeffrey L. Arnold, Colorado Springs, CO (US)

(21) Appl. No.: 14/027,690

(22) Filed: Sep. 16, 2013

(51) Int. Cl. G09B 19/06; G09B 5/06; G06F 17/28

(52) U.S. Cl. CPC G09B 19/06; G06F 17/28; G09B 5/06
USPC 434/157

(57) ABSTRACT

The present invention provides a method and system for teaching a language to a user. An index with expression records is accessed. Each expression record has at least one image search expression. One of the expression records in the index is examined to identify at least one image search expression for the examined record. A translated expression is acquired. At least one image associated with each identified image search expression is sought. The translated expression and at least one of the images are displayed to the user.

### BACKGROUND

Conventional language teaching systems often include a database of original language expressions matched with three types of content: the equivalent foreign language expression, an audio representation of the foreign language expression, and an image representing the expression. These three types of content are either included in or have links to them in the database with the original language expression. For each original language expression to be taught, the content is extracted from the database and presented to the user together so that the user will learn to associate what is seen in the image with the written and spoken expression.

These types of conventional language teaching systems are expensive to produce because for each original language expression in the index, each of the three types of content must be produced and stored in the system. Voice actors must be hired to create audio representations for each original language expression. Someone must be hired to create a foreign language translation for each original language expression. Photographers or artists must be hired to create an image for each original language expression. Although creating an image representation of the expression “an apple” is not very difficult, creating an image representation of the expression, “the boy jumped,” is more complicated.

### DESCRIPTION OF THE DRAWINGS

FIG. 1 is a block diagram representing one embodiment of the system of the present invention for teaching language.

FIG. 2 is a block diagram further representing one embodiment of the system of the present invention for teaching language.

FIG. 3 is a flow chart representing one embodiment of the method of the present invention for teaching language.

FIG. 4 is a flow chart representing one embodiment of a method for retrieving and displaying images.

FIG. 5 is a flow chart representing an alternate embodiment of a method for retrieving and displaying images.

FIG. 6 is a flow chart representing another embodiment of a method for retrieving and displaying images.

FIG. 7 is a block diagram representing one embodiment of a system for retrieving and displaying images.

FIG. 8 is another block diagram representing an alternate embodiment of the system of the present invention for teaching language.

FIG. 9 is a block diagram representing an alternate embodiment of a system for retrieving and displaying images.

FIG. 10 is another block diagram representing one embodiment of the system of the present invention for teaching language.

FIG. 11 is a block diagram representing another embodiment of a system for retrieving and displaying images.

### DETAILED DESCRIPTION

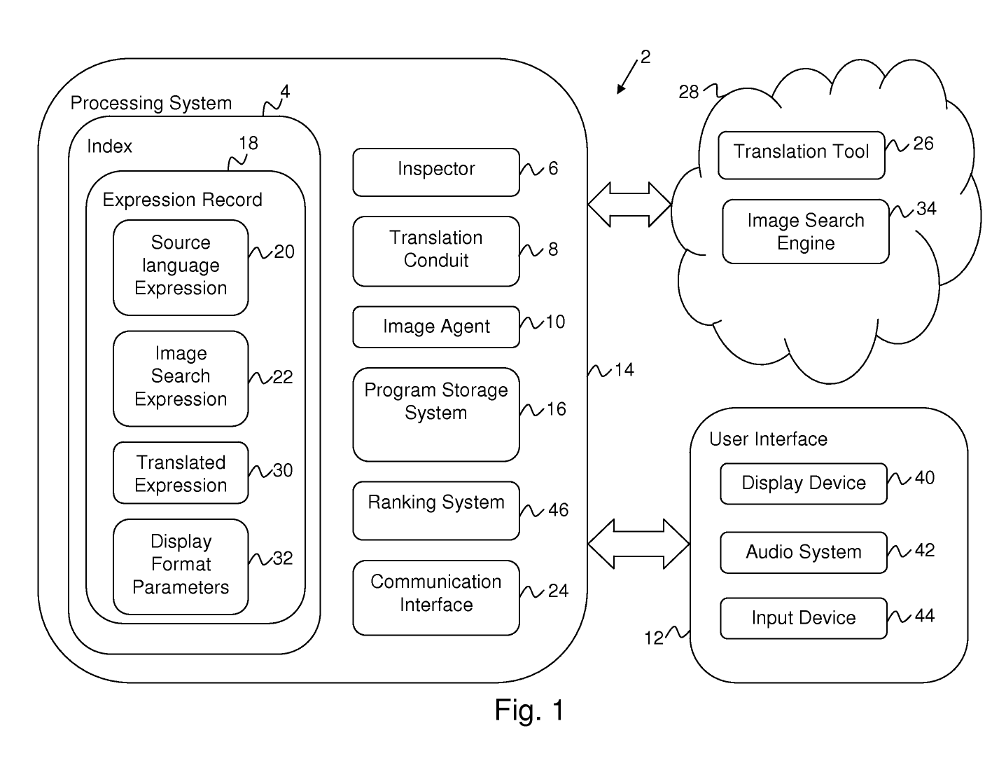

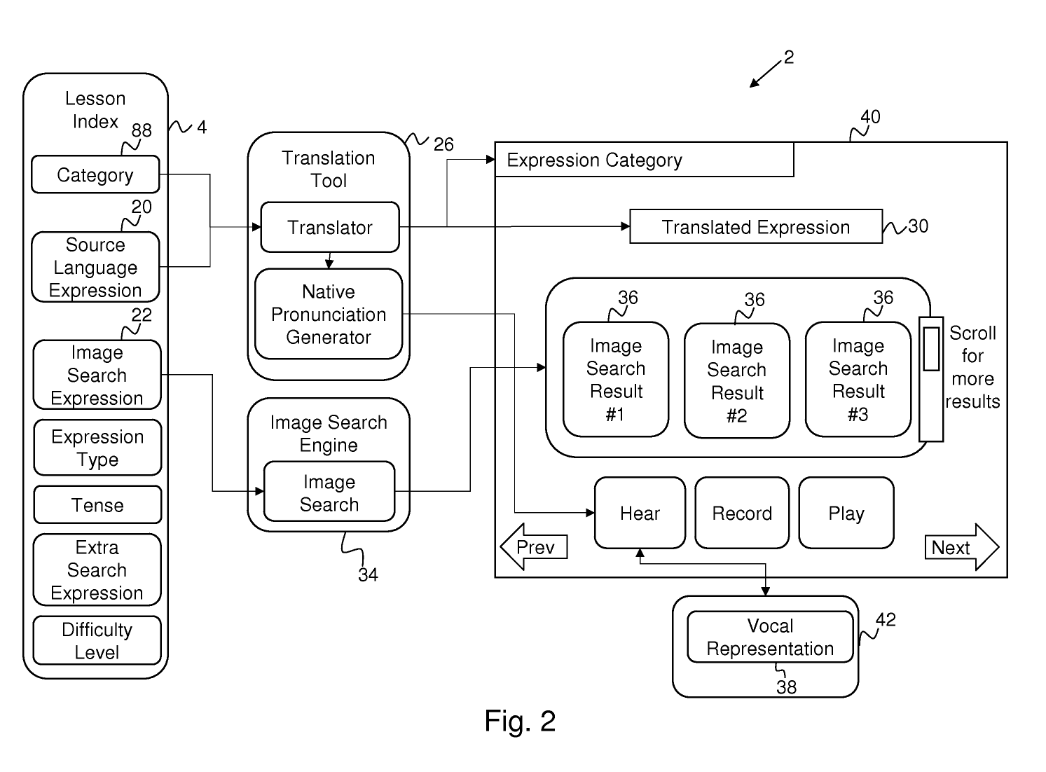

Language teaching system 2 is illustrated in FIGS. 1 and 2. Language teaching system 2 includes index 4, inspector 6, translation conduit 8, image agent 10, user interface 12, processing system 14, program storage system 16, and communication interface 24. Language teaching system 2 may be accessed by a user on a local computer or over a computer network 28, such as a local network or the internet.

Index 4 is any index for aggregating data. Examples of index 4 include a database, a spreadsheet, a table, a list, and a file. Index 4 includes a plurality of expression records 18. In one embodiment, each expression record 18 has a source language expression 20 and at least one image search expression 22. In another embodiment, each expression record 18 has a translated expression 30 and at least one image search expression 22. The word “expression” refers to anything from a single word or phrase to an entire sentence or multiple sentences, phrases, or words. Each expression record 22 may also contain display format parameters 32.

Inspector 6 is any combination of hardware and executable code configured to examine one of the expression records 18 in index 4 to identify at least one image search expression 22 for the examined record 18. In one embodiment, inspector 6 is executable code performed by processing system 14 to examine one of the expression records 18 in index 4 to identify at least one image search expression 22 for the examined record 18. In an alternate embodiment, inspector 6 is further configured to identify source language expression 20. In another embodiment, inspector 6 is further configured to identify display format parameters 32.

Translation conduit 8 is any combination of hardware and executable code configured to acquire translated expression 30. In one embodiment, translation conduit 8 supplies identified source language expression 20 to translation tool 26 accessed over a computer network 28 and obtains translated expression 30 from the output of translation tool 26. In one embodiment, translation conduit 8 is executable code performed by processing system 14 to supply identified source language expression 20 to translation tool 26 accessed over a computer network 28 and obtain translated expression 30 from the output of translation tool 26. In one embodiment, identified source language expression 20 is in a first language and translated expression 30 is in a second language, different than the first language.

In an alternate embodiment, translation conduit 8 is any combination of hardware and executable code configured to examine the expression record 18 examined by inspector 6 to identify translated expression 30. In one embodiment, inspector 6 is executable code performed by processing system 14 to examine the expression record 18 examined by inspector 6 to identify translated expression 30.

Translation tool 26 is any translation tool outside of language teaching system 2 and accessible by language teaching system 2 for translating expressions. Examples of translation tools include Google® Translate and Bing® Translator.

In one embodiment, translation conduit 8 is further configured to supply identified source language expression 20 to translation tool 26 accessed over computer network 28 and obtain vocal representation 38, also referred to as audio example 38 or audio pronunciation clip 38, of translated expression 30 from the audio output of translation tool 26. The audio output of translation tool 26 is usually in the form of a digitized audio clip which pronounces translated expression 30. In this embodiment, language teaching system 2 further includes audio system 42. Audio system 42 is a system capable of producing audible sounds, such as one or more speakers. Audio system 42 is configured to audibly produce vocal representation 38 to the user.

Image agent 10 is any combination of hardware and executable code configured to supply identified image search expression 22 to image search engine 34 accessed over computer network 28 and obtain at least one image 36 from the output of image search engine 34. In one embodiment, image agent 10 is executable code performed by processing system 14 to supply identified image search expression 22 to image search engine 34 accessed over computer network 28 and obtain at least one image 36 from the output of image search engine 34.

Image search engine 34 is any image search engine accessible by language teaching system 2 for searching images outside of index 4. Examples of image search engines include Google@ Image Search and Bing® Images.

User interface 12 is any system for displaying information to a user. User interface 12 may include a display device 40, such as a computer monitor or television, an audio system 42, and input devices 44 such as a computer keyboard and mouse. User interface 12 is configured to display translated expression 30 and at least one of the images 36 to the user.

Processing system 14 is any device or system configured to process executable code. Processing system 14 may be a specific or general purpose processor, such as a computer processor or a specific or general purpose computer.

Program storage system 16 is any system configured to store data or executable code. Program storage system 16 may also be a program storage system tangibly embodying a program, applet, or instructions executable by processing system 14 for performing the method steps of the present invention executable by processing system 14. Program storage system 16 may be any type of storage media such as magnetic, optical, or electronic storage media. Program storage system 16 is illustrated in FIG. 1 as a single device. Alternatively, program storage system 16 may include a plurality of devices. Furthermore, each device of program storage system 16 may be embodied in a different media type. For example, one device of program storage system 16 may be a magnetic storage media while another device of program storage system 16 is an electronic storage media.

Communication interface 24 is any device or system configured to provide communication between language teaching system 2 and computer network 28. Examples of communication interface 24 include a direct connection interface and a network interface.

In one embodiment, the at least one image 36 includes a plurality of images 36 and the language teaching system 2 further includes ranking system 46. Ranking system 46 is any combination of hardware and executable code configured to prioritize at least one of the images 36. In one embodiment, ranking system 46 is executable code performed by processing system 14 to prioritize at least one of the images 36. In this embodiment, user interface 12 is further configured to display each prioritized image 36 to the user.

In one embodiment, ranking system 46 is further configured to accept payment to prioritize an image 36. In another embodiment, ranking system 46 is further configured to permit a user to vote to prioritize an image 36.

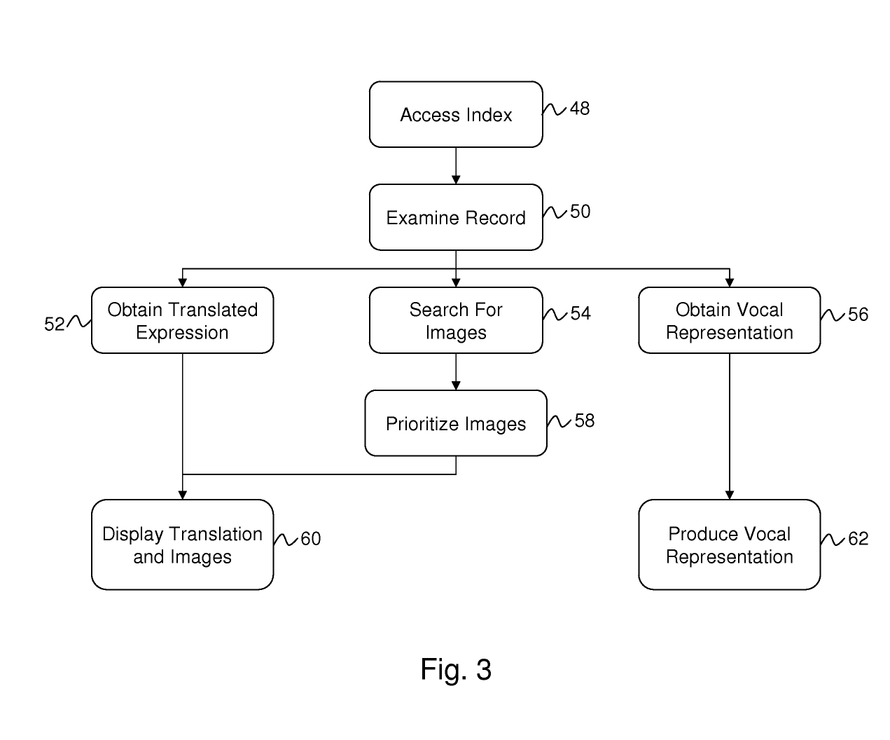

FIG. 3 is a flow chart representing steps of one embodiment of the present invention. Although the steps represented in FIG. 3 are presented in a specific order, the present invention encompasses variations in the order of steps. Furthermore, additional steps may be executed between the steps illustrated in FIG. 3 without departing from the scope of the present invention.

Index 4 is accessed 48. One of the expression records 18 in index 4 is examined 50 to identify at least one image search expression 22. In an alternate embodiment, expression record 18 is further examined 50 to identify source language expression 20. In another embodiment, expression record 18 is further examined 50 to identify display format parameters 32.

Translated expression 30 is obtained 52. In one embodiment, translation expression is obtained by examining the previously examined expression record 18 to identify translated expression 30. In an alternate embodiment, identified source language expression 20 is translated into translated expression 30. Translated expression 30 is not retrieved from index 4, but rather from an outside source, such as an internet based, or online, translation tool 26. In one embodiment, translating identified source language expression 20 includes supplying identified source language expression 20 to translation tool 26 accessed over computer network 28 and obtaining a visual output of translation tool 26 as translated expression 30.

At least one image 36 associated with identified image search expression 22 is sought 54 outside of index 4. In one embodiment, searching 54 for at least one image 36 includes supplying identified image search expression 22 to image search engine 34 accessed over computer network 28 and obtaining the output of image search engine 34 as the at least one image 36.

In one embodiment, vocal representation 38 of translated expression 30 is also obtained 56. In one embodiment, obtaining 56 vocal representation 38 of translated expression 30 includes supplying identified source language expression 20 to translation tool 26 accessed over computer network 28 and obtaining an audio output of translation tool 26 as vocal representation 38.

In one embodiment, the at least one image 36 includes a plurality of images 36. At least one of the images 36 is prioritized 58 and the at least one prioritized image 36 is displayed 60. In one embodiment, prioritizing 58 at least one image 36 includes accepting payment to prioritize 58 an image. In one embodiment, prioritizing 58 at least one image 36 includes permitting a user to vote to prioritize 58 an image.

The images 36 may be sponsored by a company or other entity, or otherwise given priority 58 over other images 36, causing these images 36 to always be presented to the user when certain expressions are being taught, and to show up with higher priority in a position which will likely get them noticed by the user before non-sponsored images are noticed.

Translated expression 30 and at least one of the images 36 are displayed 60 to the user. In one embodiment, vocal representation 38 is audibly produced 62 to the user. In one embodiment, the images 36 presented 60 to the user by language teaching system 2 will respond the same way to user input as they would in a browser environment. For example, if the user clicks one of the images 36 presented 60, a web browser might open and take the user to the source of the image 36.

In practice in one embodiment, language teaching system 2 displays an expression from the source language to the user in the language being taught based on a lesson plan. The user does not necessarily type in an expression in the source language, because the idea is that the user never sees the expression in any language other than the language being taught. Instead, language teaching system 2 determines what source language expression will be taught to the user next. Language teaching system 2 only knows this expression in one language, the source language.

Each expression to be taught to the user in index 4 is stored in a single language, the source language. When translated expression 30 is sought by language teaching system 2, the system will output the source language version of whatever expression is going to be taught to an online translation engine 26. Language teaching system 2 will then retrieve the translated version 30 of the expression, as well as an audio pronunciation example 38 of the expression, from the online translation engine 26. Language teaching system 2 will then present 60, 62 this translated expression 30 and audio example 38 to the user.

In one embodiment for translating, language teaching system 2 inputs source language expression 20 into online translator 26, as well as parameters defining which language is being translated into which language and retrieves the resulting translated expression 30 in the language being taught. Language teaching system 2 also retrieves the resulting audio pronunciation clip 38.

Language teaching system 2 displays 60 the resulting translated expression 30 in the language being taught to the user. Language teaching system 2 also plays 62 audio pronunciation clip 38 to the user.

At least one image search expression 22 is associated with each source language expression 20. Each image search expression 22 is designed to retrieve images 36 which convey the translated expression 30 being taught. When language teaching system 2 presents a user with a translated expression 30, image agent 10 will output the image search expression 22 associated with the translated expression 30 being taught to image search engine 34. Language teaching system 2 will then retrieve any number of resultant image search result images 36. Language teaching system 2 will then present 60 any number of these images 36 to the user along with translated expression 30 and audio pronunciation 38, or vocal representation 38, of translated expression 30.

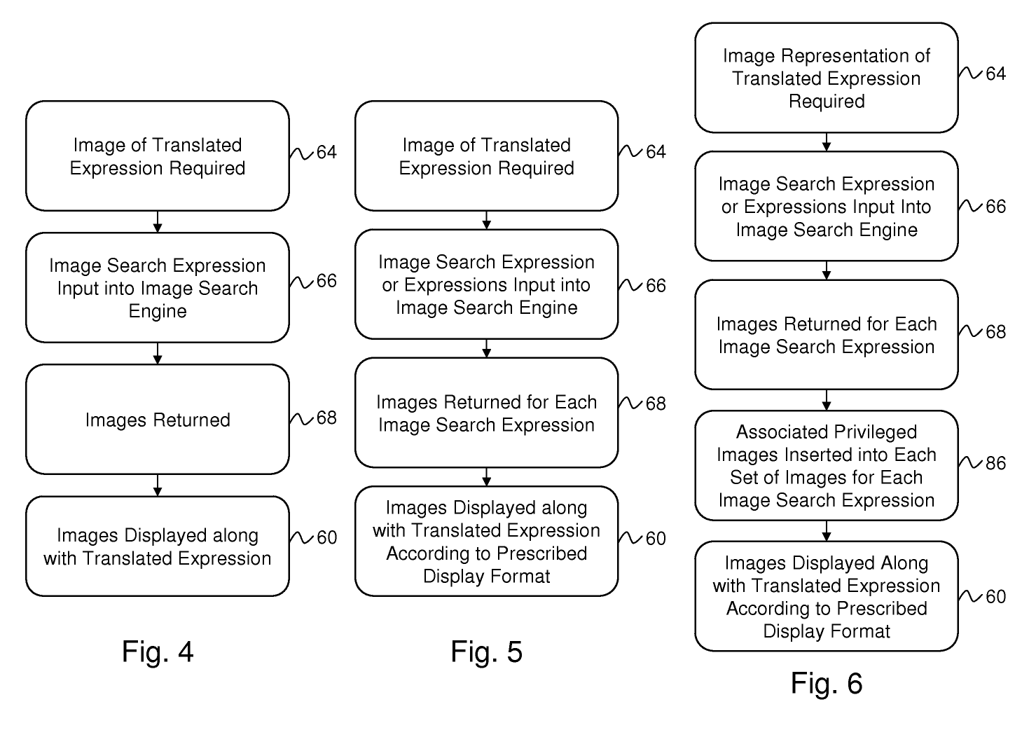

FIG. 4 is a flow chart representing one embodiment of searching 54 for images 36. This is an example of the method of retrieving a single set of images 36 for translated expression 30. When an image of translated phrase 30 is required 64, image search expression 22 is input 66 into image search engine 34. Images 36 are returned 68. Images 36 are then displayed 60 along with translated expression 30.

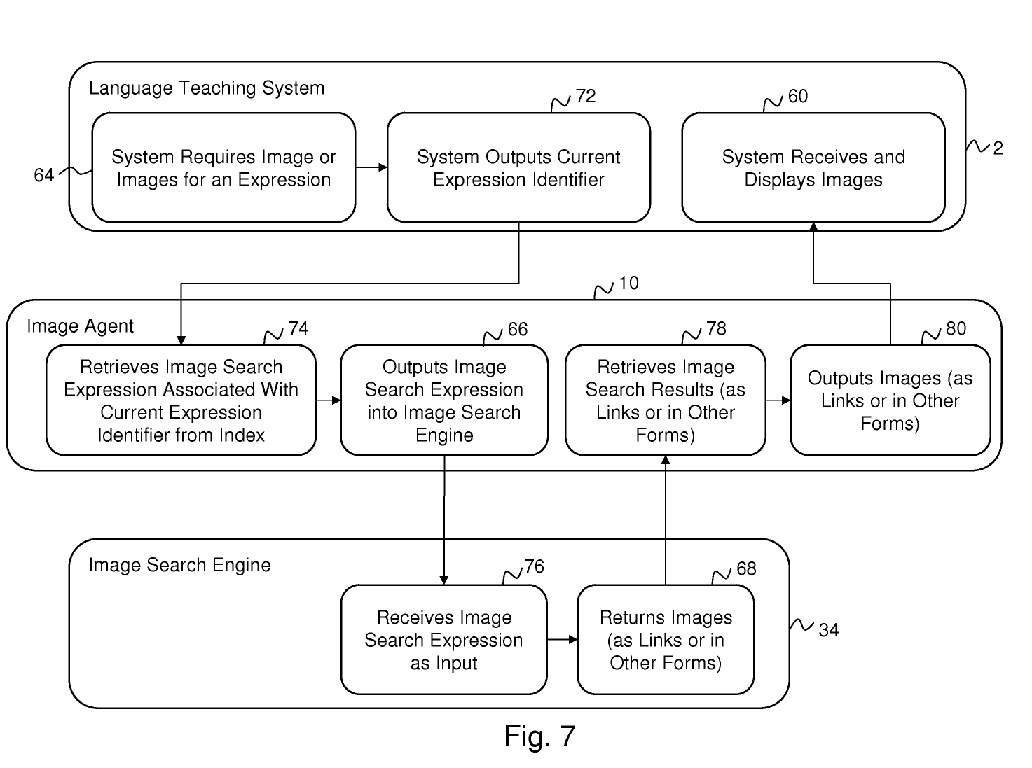

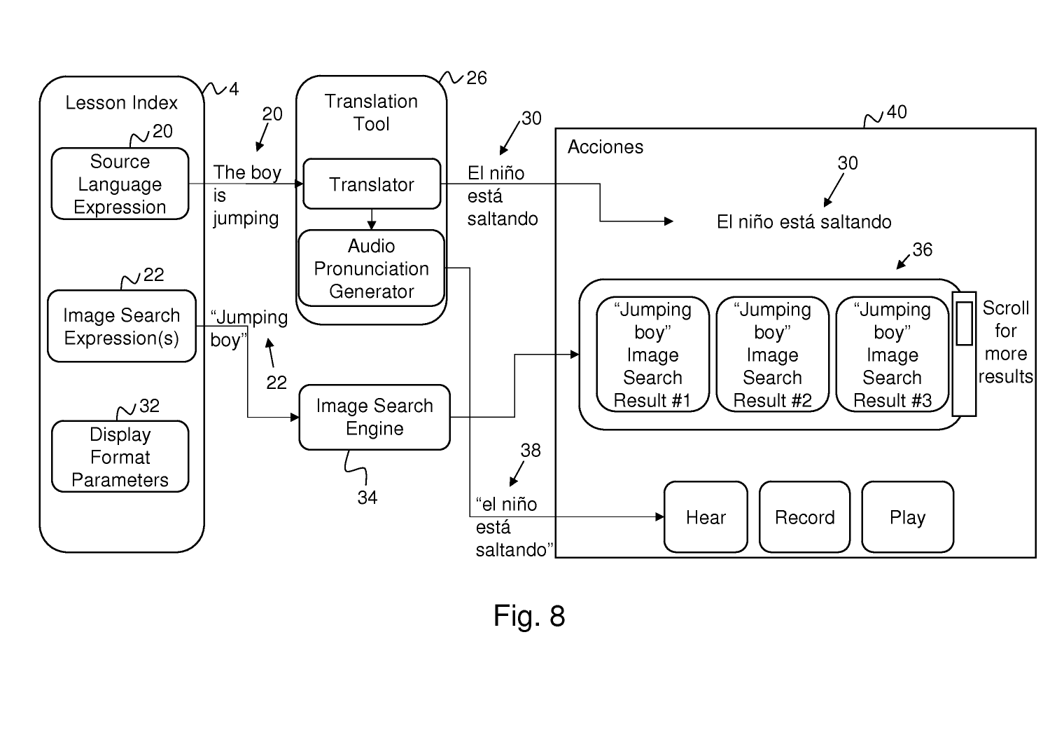

An example of how this method may be implemented is related in FIGS. 7 and 8. When images are required 64, language teaching system 2 outputs 72 a current expression identifier to image agent 10. The current expression identifier is an identification of which expression record 18 to look at for the image search expression 22. Image agent 10 retrieves 74, from index 4, the image search expression 22 associated with the current expression identifier. Image search expression 22 is output 66 to image search engine 34. Image search engine 34 receives 76 image search expression 22 as an input. Image search engine 34 returns 68 images 36 as links or in any other usable form to access images 36. Image agent 10 retrieves 78 images 36 and outputs 80 images 36 to language teaching system 2. Language teaching system 2 displays 60 images 36.

FIG. 5 represents an alternate and more complex embodiment of searching 54 for images 36. This describes the method of retrieving multiple sets of images 36 for translated expression 30. This method is helpful when attempting to convey more complex expressions. For example, the source language expression 20 “They jumped” may be conveyed by displaying 60 images 36 of people jumping followed by images 36 of people standing. Applying any number of display layout formats when displaying 60 translated expression 30 and images 36 to the user would help to make the point that these people jumped in the past but are now standing.

When an image of translated phrase 30 is required 64, one or more image search expressions 22 is input 66 into image search engine 34. Images 36 are returned 68 for each image search expression 22. Images 36 are then displayed 60 along with translated expression 30 according to a prescribed display format.

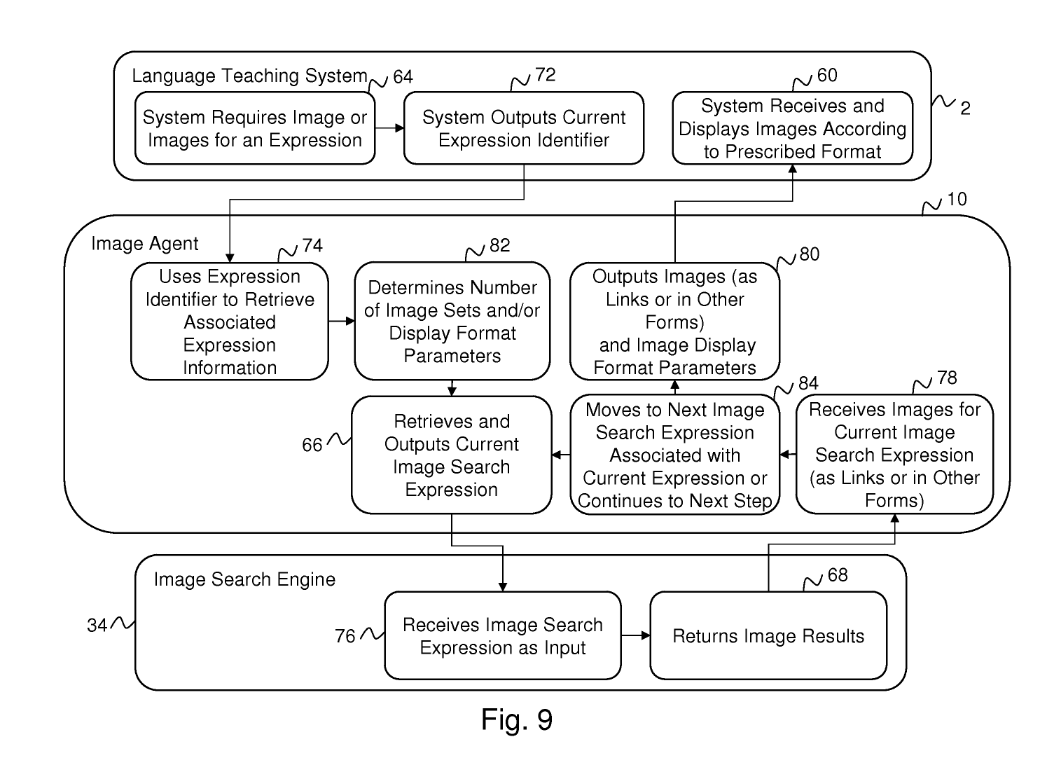

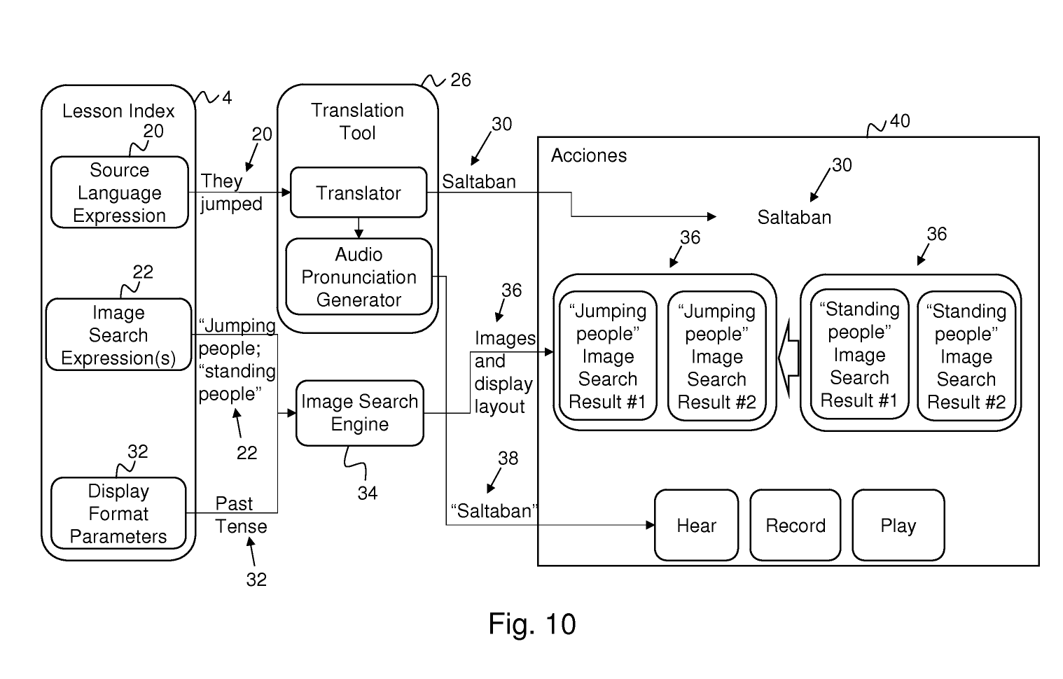

An example of how this method may be implemented is related in FIGS. 9 and 10. When images are required 64, language teaching system 2 outputs 72 a current expression identifier to image agent 10. Image agent 10 retrieves 74, from index 4, expression information associated with the current expression identifier. The expression information is the one or more image search expressions 22 and any display format parameters 32 associated with the current expression identifier. The display format parameters 32 are the instructions for how to display images 36 associated with each image search expression 22. The number of image search expressions 22 associated with the current expression identifier is determined 82.

For each image search expression, the image search expression 22 is output 66 to image search engine 34. Image search engine 34 receives 76 image search expression 22 as an input. Image search engine 34 returns 68 images 36 as links or in any other usable form to access images 36. Image agent 10 retrieves 78 images 36. A check is made to determine 84 whether images 36 for all of the image search expressions 22 have been received. If not, the next image search expression 22 is processed. If images 36 for all of the image search expressions 22 have been received, image agent 10 outputs 80 images 36 and image display format parameters 32 to language teaching system 2. Language teaching system 2 displays 60 images 36.

FIG. 6 represents another more complex embodiment of searching 54 for images 36. This describes the method by which images 36 designated as privileged, or prioritized, may be added to the top of the list of image results. Using this method a company or other entity could pay for their images 36 to show up first, thereby advertising their product while providing language teaching system 2 with an image 36 or images 36 which very accurately convey translated expression 30.

When an image of translated phrase 30 is required 64, one or more image search expressions 22 is input 66 into image search engine 34. Images 36 are returned 68 for each image search expression 22. Privileged, or prioritized, images 36 associated with each image search phrase 22 are inserted 86 into each set of images 36 for the image search phrase 22. Images 36 are then displayed 60 along with translated expression 30 according to a prescribed display format defined by display parameters 32.

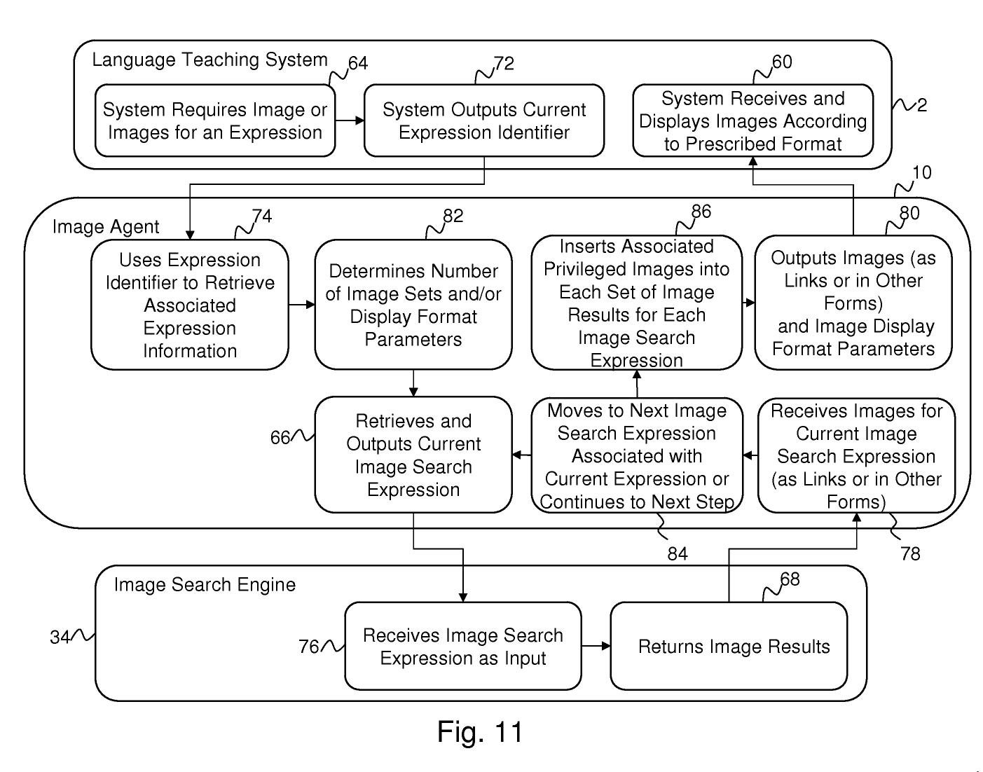

An example of how this method may be implemented is related in FIG. 11. When images are required 64, language teaching system 2 outputs 72 a current expression identifier to image agent 10. Image agent 10 retrieves 74, from index 4, expression information associated with the current expression identifier. The number of image search expressions 22 associated with the current expression identifier is determined 82.

For each image search expression, the image search expression 22 is output 66 to image search engine 34. Image search engine 34 receives 76 image search expression 22 as an input. Image search engine 34 returns 68 images 36 as links or in any other usable form to access images 36. Image agent 10 retrieves 78 images 36. A check is made to determine 84 whether images 36 for all of the image search expressions 22 have been received. If not, the next image search expression 22 is processed. If images 36 for all of the image search expressions 22 have been received, privileged, or prioritized, images 36 associated with each image search phrase 22 are inserted 86 into each set of images 36 for the image search phrase 22. Image agent 10 outputs 80 images 36 and image display format parameters 32 to language teaching system 2. Language teaching system 2 displays 60 images 36.

One advantage the present invention is that it provides an inexpensive method of presenting 60 image representations 36 of expressions being taught to a user by language learning system 2 through use of an online image search engine 34. The present invention further provides a means by which one may not only be provided these images 36 at no cost, but also profit from displaying images 36 with advertising purposes. Another advantage of the present invention is that it is an inexpensive method of presenting a wide variety of translated expressions 30 and accompanying audio pronunciation examples 38 for any language being taught in language teaching system 2.

Wherever possible, steps or components that are alike from figure to figure have been numbered alike. The foregoing description is only illustrative of one embodiment of the present invention. Various alternatives and modifications may be devised by those skilled in the art without departing from the present invention. Accordingly, the present invention embraces all such alternatives, modifications, and variances that fall within the scope of the appended claims.

What is claimed is:

1. A method for teaching a language to a user, the method comprising:
accessing an index having a plurality of expression records, each expression record having at least one image search expression;
examining one of the expression records in the index to identify at least one image search expression for the examined record;
acquiring a translated expression;
searching for at least one image representative of each identified image search expression; and
displaying the translated expression and at least one of the images to the user.

2. The method of claim 1 wherein:
each search record further includes a translated expression and
acquiring the translated expression includes examining the examined expression record identify the translated expression.

3. The method of claim 1 wherein:
each search record further includes a source language expression;
examining one of the expression records in the index further includes examining one of the expression records in the index to identify a source language expression; and
acquiring the translated expression includes translating the identified source language expression into a translated expression, wherein the identified source language expression is in a first language and the translated expression is in a second language, different than the first language.

4. The method of claim 3 wherein:
translating the identified source language expression includes supplying the identified source language expression to a translation tool and obtaining a visual output of the translation tool as the translated expression and
searching for at least one image includes supplying each identified image search expression to an image search engine and obtaining the output of the image search engine as the at least one image.

5. The method of claim 4 wherein the translation tool and the image search engine are accessed over a computer network.

6. The method of claim 1 further including obtaining a vocal representation of the translated expression and further including audibly producing the vocal representation to the user.

7. The method of claim 6 wherein obtaining the vocal representation of the translated expression includes supplying the identified source language expression to a translation tool and obtaining an audio output of the translation tool as the vocal representation.

8. The method of claim 7 wherein the translation tool is accessed over a computer network.

9. The method of claim 1 wherein the at least one image includes a plurality of images and further including prioritizing at least one of the images and wherein displaying the at least one image to the user includes displaying each prioritized image.

10. The method of claim 9 wherein prioritizing at least one image includes accepting payment to prioritize an image.

11. The method of claim 9 wherein prioritizing at least one image includes permitting a user to vote to prioritize an image.

12. A system for teaching a language to a user for use with an image search engine accessible by the system, the system comprising:
an index having a plurality of expression records, each expression record having at least one image search expression;
an inspector configured to examine one of the expression records in the index to identify at least one image search expression for the examined record;
a translation conduit configured to acquire a translated expression;
an image agent configured to supply each identified image search expression to the image search engine and obtain at least one image from the output of the image search engine; and
a user interface configured to display the translated expression and at least one of the images to the user.

13. The system of claim 12 wherein:
each search record further includes a translated expression and
the translation conduit is configured to acquire the translated expression by examining the examined expression record to identify the translated expression.

14. The system of claim 12 wherein:
the system for teaching a language to a user is further for use with a translation tool;
each search record further includes a source language expression;
the inspector is further configured to identify a source language expression from the examined expression record; and
the translation conduit is configured to acquire the translated expression by supplying the identified source language expression to the translation tool and obtain a translated expression from the output of the translation tool, wherein the identified source language expression is in a first language and the translated expression is in a second language, different than the first language.

15. The system of claim 12:
wherein the system for teaching a language to a user is further for use with a translation tool and the translation conduit is further configured to supply the identified source language expression to a translation tool and obtain a vocal representation of the translated expression from the output of the translation tool and
further including an audio system configured to audibly produce the vocal representation to the user.

16. The system of claim 15 wherein the translation tool is accessed over a computer network.

17. The system of claim 12 wherein the at least one image includes a plurality of images and further including a ranking system configured to prioritize at least one of the images and wherein the user interface is further configured to display each prioritized image to the user.

18. The system of claim 17 wherein the ranking system is further configured to accept payment to prioritize an image.

19. The system of claim 17 wherein the ranking system is further configured to permit a user to vote to prioritize an image.

20. A program storage system readable by a computer, tangibly embodying a program, applet, or instructions executable by the computer to perform a method for teaching a language to a user, the method comprising:
accessing an index having a plurality of expression records, each expression record having at least one image search expression;
examining one of the expression records in the index to identify at least one image search expression for the examined record;
acquiring a translated expression;
searching for at least one image representative of each identified image search expression; and
displaying the translated expression and at least one of the images to the user.

21. The program storage system of claim 20 wherein:
each search record further includes a translated expression and
acquiring the translated expression includes examining one of the expression records in the index to identify the translated expression.

22. The program storage system of claim 20 wherein:
each search record further includes a source language expression;
examining one of the expression records in the index further includes examining one of the expression records in the index to identify a source language expression; and
acquiring the translated expression includes translating the identified source language expression into a translated expression, wherein the identified source language expression is in a first language and the translated expression is in a second language, different than the first language.

23. The program storage system of claim 22 wherein:
translating the identified source language expression includes supplying the identified source language expression to a translation tool and obtaining a visual output of the translation tool as the translated expression, and
searching for at least one image includes supplying each identified image search expression to an image search engine and obtaining the output of the image search engine as the at least one image.

24. The program storage system of claim 23 wherein the translation tool and the image search engine are accessed over a computer network.

25. The program storage system of claim 20 wherein the method further includes obtaining a vocal representation of the translated expression and further including audibly producing the vocal representation to the user.

26. The program storage system of claim 24 wherein obtaining the vocal representation of the translated expression includes supplying the identified source language expression to a translation tool and obtaining an audio output of the translation tool as the vocal representation.

27. The program storage system of claim 26 wherein the translation tool is accessed over a computer network.

28. The program storage system of claim 20 wherein the at least one image includes a plurality of images and further including prioritizing at least one of the images and wherein displaying the at least one image to the user includes displaying each prioritized image.

29. The program storage system of claim 28 wherein prioritizing at least one image includes accepting payment to prioritize an image.

30. The program storage system of claim 28 wherein prioritizing at least one image includes permitting a user to vote to prioritize an image.
